(19) United States
(12) Patent Application Publication
(10) Pub. No.: US 2024/0425104 A1
(43) Pub. Date: Dec. 26, 2024

(54) SYSTEM ARCHITECTURES FOR STEERING AND WORK FUNCTIONS IN A WHEEL LOADER

(71) Applicant: Parker-Hannifin Corporation, Cleveland, OH (US)

(72) Inventors: Hao Zhang, Twinsburg, OH (US); Raymond Collett, Put-in-Bay, OH (US); Rajneesh Kumar, Mayfield Heights, OH (US); Qiang Wang, Shanghai (CN); Miao Zhang, Shanghai (CN); James Howland, Marysville, OH (US)

(73) Assignee: Parker-Hannifin Corporation, Cleveland, OH (US)

(21) Appl. No.: 18/822,691

(22) Filed: Sep. 3, 2024

Related U.S. Application Data
(63) Continuation of application No. 17/234,120, filed on Apr. 19, 2021.
Application No. 17/234,120 is a continuation of application No. 15/529,336, filed on May 24, 2017, now abandoned.
(60) Provisional application No. 62/083,876, filed on Nov. 24, 2014.
(60) Provisional application No. 62/197,209, filed on Jul. 27, 2015.

(51) Int. Cl. B62D 5/07; B62D 5/10; B62D 12/00; E02F 9/08; E02F 9/22; F15B 11/16; F15B 13/02; F15B 13/044

(52) U.S. Cl. CPC B62D 5/075; B62D 5/10; B62D 12/00; E02F 9/0841; E02F 9/2203; E02F 9/2228; E02F 9/225; E02F 9/2285; E02F 9/2292; E02F 9/2296; F15B 11/162; F15B 13/022; F15B 13/025; F15B 13/044; F15B 2211/20553; F15B 2211/20576; F15B 2211/50563; F15B 2211/5151; F15B 2211/7142; F15B 2211/781

(57) ABSTRACT

A hydraulic system for a work machine comprising a priority circuit including at least a first priority actuator and a priority control valve for controlling the supply of hydraulic fluid to the first priority actuator and for providing a load sense signal indicative of the load acting on the first priority actuator; an auxiliary circuit including at least a first auxiliary actuator and at least a first auxiliary control valve for controlling the supply of hydraulic fluid to the first auxiliary actuator; at least a first pump for producing a flow of hydraulic fluid; and a priority valve for distributing the flow from the pump to the priority circuit and auxiliary circuit for operating the respective actuators thereof, with priority being given to the priority circuit as a function of the load sense signal.

### RELATED APPLICATION DATA

This application is a continuation of U.S. application Ser. No. 17/234,120 filed on Apr. 19, 2021, which is a continuation of U.S. application Ser. No. 15/529,336 filed on May 24, 2017, which is a national phase entry of International Patent Application No. PCT/US2015/062380 filed on Nov. 24, 2015, which claims the benefit of U.S. Provisional Application No. 62/083,876 filed on Nov. 24, 2014, and U.S. Provisional Application No. 62/197,209 filed on Jul. 27, 2015, the entire disclosures of which are hereby incorporated herein by reference in their entireties.

### FIELD OF THE INVENTION

The present invention relates to hydraulic control systems for steering and auxiliary functions in off-road vehicles.

### BACKGROUND

Off-road construction vehicles such as skidders, loaders and scrapers, and the like, have used hydraulically fed steering systems which make it possible for large vehicles to be maneuvered with relative ease during all operations. Such vehicles are also provided with hydraulically fed auxiliary function capabilities to operate such things as grapples, loader buckets and scraper blades. The auxiliary functions often share hydraulic fluid with the steering system. Conventionally, hydraulic fluid is passed through a priority valve which branches fluid to both the steering system and the auxiliary functions, usually giving priority to the steering system. That is, the fluid requirements of the steering system have preemption over the fluid requirements of the auxiliary function(s).

Conventionally, the priority valve includes a valve spool acted upon by fluid pressure to overcome a spring and assume a first spool position. The first position allows the priority valve to port fluid to both the main steering valve of the steering system and to the auxiliary functions. When the fluid pressure drops below a predetermined amount occasioned by a reduction in hydraulic circuit pressure, the spring force on the valve spool shifts the valve spool to a second position porting all incoming fluid to the main steering valve.

U.S. Pat. No. 3,455,210 discloses a system wherein fluid to both a priority load circuit and an auxiliary load circuit is effected by means of a single fluid source and a single priority flow control valve. It is also known in the art to provide pressurized fluid to both a priority load circuit and an auxiliary load circuit by means of a pair of fluid sources and a valving arrangement which typically directs all of the flow from the primary source to the priority load circuit, while directing fluid from the secondary source to the priority load circuit, only as needed.

To make more efficient use of the hydraulic power developed for the steering system, according to the U.S. Pat. No. 4,215,720, a pressure compensator senses the normal hydraulic steering load, and makes any excess fluid power output of a steering pump available for control of an implement. The system according to this patent is primarily for light equipment where a single pump can be used for both implement and steering control, with priority given to steering control to prevent the loss of steering due to implement overload.

Energy saving and easy operability are gaining more attention in off-road construction machinery design. A conventional wheel loader represents a platform where it is desirable to improve system efficiency while coordinating multiple functions being performed during a typical duty cycle. System design involves managing the interaction of steering and implement systems, through pump flow sharing, to achieve the dual objectives of high efficiency and acceptable system response to operator inputs.

The steering circuit design, in particular, should avoid stability and oscillation issues in a wheel loader application. Due to the nature of the load, steering tends to suffer from shock at the start of the steering effort that should be suppressed to retain productivity and operability. The system design is complicated by the fact that implements, i.e. boom and bucket, and steering systems share the total pump flow that must be divided to fulfill the operator demand without compromising the overall performance.

Selecting the number and type(s) of pumps to meet total flow demand while achieving load matching to minimize losses is another design decision that affects energy efficiency of the system. Various architectures involving single or multiple pumps of fixed or variable displacement type are known in the art and have their own advantages and drawbacks.

European Patent Application No. 2,123,541 A1 discloses a solution for suppressing shock in a steering system of a working vehicle that utilizes a different version of a pre-compensator valve. The pre-compensator valve has the same purpose, i.e. controlling the differential pressure across and hence flow rate through the steering valve, but lacking is any suggestion of a multi-pump architecture or steering manifold design that divides the flow between steering and implement sections.

### SUMMARY OF THE INVENTION

The present invention provides various novel arrangements for control and distribution of hydraulic flow between steering and implement functions.

Steering priority can be achieved via a priority valve proportional to a steering command. An operator can feel the same steering wheel force when steering and implement happen at the same time and when only steering.

In a preferred embodiment, a priority valve, shuttle valve, selection valve, pressure reducing valve, and sequence valve are integrated into a single manifold

Implement actuation can be an open center system although closed center systems also are contemplated.

A novel unloading valve arrangement provides efficient fixed pump unloading function and minimizes the system flow disturbance.

Also disclosed is direct electronic control architectures that enable a more simplified hydraulic circuit and provide greater energy saving.

According to one aspect of the invention, a hydraulic system for a work machine comprises a priority circuit including at least a first priority actuator and a priority control valve for controlling the supply of hydraulic fluid to the first priority actuator and for providing a load sense signal indicative of the load acting on the first priority actuator; an auxiliary circuit including at least a first auxiliary actuator and at least a first auxiliary control valve for controlling the supply of hydraulic fluid to the first auxiliary actuator; at least a first pump for producing a flow of hydraulic fluid; and a priority valve for distributing the flow from the pump to the priority circuit and auxiliary circuit for operating the respective actuators thereof, with priority being given to the priority circuit as a function of the load sense signal.

A pressure reducing valve may be connected between the pump and the priority control valve for controlling the flow rate of hydraulic fluid supplied to the priority control valve.

A pre-compensation valve may be connected between the pump and the priority control valve for controlling the flow rate of hydraulic fluid supplied to the priority control valve.

The pressure reducing valve or the pre-compensation valve may receive a pilot control pressure from a controller that determines the pressure drop across the priority control valve.

The controller may have associated therewith one or more pressure sensors for sensing pressures in the system, such as a pressure sensor for sensing the pressure at the outlet of the pump and a pressure sensor for sensing the load sense pressure.

A load sense may supply the load sense signal to a pilot port of the priority valve, such that the position of the priority valve is determined as a function of the load present on the first priority actuator.

The first pump may be a fixed displacement pump or a variable displacement pump.

The displacement of the first pump may be varied by a controller as a function of the load sense signal.

The displacement of the first pump may be varied by a controller as a function of the load acting on the first auxiliary actuator.

A 2-position, 3-way valve may be used to feed pressure to a pilot port of the priority valve.

The 2-position, 3-way valve may remain closed until the highest pilot pressure signal supplied from a joystick overcomes a spring force, after which the priority valve can shift toward an open position for supplying the line sense signal to a pilot port of the priority valve.

The first auxiliary control valve is of the closed-centered type, a post-compensated closed-centered type, or an open-centered type.

The pump displacement may be controlled by an electronic controller as a function of one or more of the load sense signal, an auxiliary load sense signal, and a pump outlet pressure signal.

The displacement of the pump and control of at least one of the valves may be performed simultaneously.

The system may include a second pump for producing hydraulic flow.

The second pump may supply hydraulic flow to the auxiliary circuit, and the first pump may supply hydraulic flow to the priority circuit.

The first pump may supply hydraulic flow to the priority circuit on a priority basis, with any excess flow being supplied to the auxiliary circuit.

The first and second pumps may be a fixed displacement pump or variable displacement pump.

When there is no demand in the priority circuit, all pump flow may be routed to auxiliary circuit.

The first pump may be a variable displacement pump, and the higher of the load sense signal or a pressure signal from the auxiliary circuit can be used to determine displacement of the first pump.

An unloading valve may be provided that unloads excess flow across a relief valve when pressure supplied to the auxiliary circuit exceeds a prescribed amount.

Stability of pressure and flow being sent to the priority circuit may be achieved through an orifice setup on a pressure reducing valve.

According to another aspect of the invention, a hydraulic system for a work machine comprises a priority circuit including at least a first priority actuator and a priority control valve for controlling the supply of hydraulic fluid to the first priority actuator; an auxiliary circuit including at least a first auxiliary actuator and at least a first auxiliary control valve for controlling the supply of hydraulic fluid to the first auxiliary actuator; at least a first pump for producing a flow of hydraulic fluid; a priority valve for distributing the flow from the pump to the priority circuit and auxiliary circuit for operating the respective actuators thereof; a manually operated input device for allowing a machine operator to input commands for commanding operation of the first priority actuator and the first auxiliary actuator and for outputting command signals indicative of the commands; and a controller configured to receive the command signals from the manually operated input device and a plurality of system parameters, and to control operation of the pump and priority valve.

The priority control valve may provide a load sense signal indicative of the load acting on the first priority actuator.

Opening of the valve and displacement of the first pump may be controlled by the controller that takes in joystick inputs, engine speed and other system parameters.

The controller can be used to compute the total flow required for work functions.

The priority circuit may be a steering circuit of a work machine and the auxiliary circuit may be the implement circuit of the work machine.

The fixed pump can be any of the following: external gear pump, internal gear pump, vane pump, or piston pump.

The foregoing and other features of the invention are hereinafter fully described and particularly pointed out in the claims, the following description and the annexed drawings setting forth in detail one or more illustrative embodiments of the invention. These embodiments, however, are but a few of the various ways in which the principles of the invention can be employed. Other objects, advantages and features of the invention will become apparent from the following detailed description of the invention when considered in conjunction with the drawings.

### BRIEF DESCRIPTION OF THE DRAWINGS

FIG. 1 is an elevational view of an exemplary work machine, in particular a front wheel loader.

FIG. 2 is a schematic illustration of an exemplary hydraulic control system including a single fixed displacement pump with open-centered implement valves.

FIG. 3 is a schematic illustration of another exemplary hydraulic control system including a single variable displacement pump with close-centered implemented valves.

FIG. 4 is a schematic illustration of yet another exemplary hydraulic control system including fixed displacement steering and implement pumps.

FIG. 5 is a schematic illustration of still another exemplary hydraulic control system including a variable displacement steering pump and a fixed displacement implement pump with open-centered implement valves.

FIG. 6 is a schematic illustration of a further exemplary hydraulic control system including a variable displacement steering pump and a fixed displacement implement pump with close-centered implement valves and an electronic pressure relief valve (PRV).

FIG. 7 is a schematic illustration of a still further exemplary hydraulic control system including a fixed displacement steering pump and a variable displacement implement pump with open-centered implement valves.

FIG. 8 is a schematic illustration of yet a further exemplary hydraulic control system including a fixed displacement steering pump and a variable displacement implement pump with closed-centered implement valves.

FIG. 9 is a schematic illustration of another exemplary hydraulic control system including a fixed displacement steering pump and a variable displacement implement pump with closed-centered implement valves and an electronic PRV.

FIG. 10 is a schematic illustration of another exemplary hydraulic control system including a fixed displacement steering and implement pumps with a priority valve an no pre-compensator valve.

FIG. 11 is a schematic illustration of another exemplary hydraulic control system including a variable displacement steering pump and a fixed displacement implement pump with an unloading valve.

FIG. 12 is a schematic of an alternative steering manifold that can be used in the hydraulic control system of FIG. 11.

FIG. 13 is a schematic illustration of another exemplary hydraulic control system including variable displacement steering implement pumps with a pressure reducing valve and no pre-compensator valve.

FIG. 14 is a schematic illustration of another exemplary hydraulic control system including a variable displacement steering pump and a fixed displacement implement pump in an intelligent flow control architecture.

FIG. 15 is a schematic illustration of another exemplary hydraulic control system including variable displacement steering and implement pumps in an intelligent flow control architecture.

FIG. 16 is a schematic illustration of another exemplary hydraulic control system including fixed displacement steering and implement pumps in an intelligent flow control architecture.

FIG. 17 is a schematic illustration of yet another exemplary hydraulic control system using intelligent flow control architecture.

FIG. 18 is a diagrammatic illustration of an intelligent flow control architecture.

FIG. 19 is a schematic illustration of a modified form of the hydraulic control system of FIG. 11, including a fixed displacement steering pump and a variable displacement implement pump with an unloading valve.

FIG. 20 is the same as FIG. 14, except the functionality of the electronic controller is illustrated in greater detail.

FIG. 21 corresponds to FIG. 2 and illustrates power flow management through use of the electronic controller.

FIG. 22 corresponds to FIG. 3 and illustrates power flow management through use of the electronic controller.

FIG. 23 is an adaptation of the architecture shown in FIG. 22.

FIG. 24 corresponds to the architecture shown in FIG. 11, illustrating steering only flow.

FIG. 25 corresponds to the architecture shown in FIG. 11, illustrating implement only power flow.

FIG. 26 corresponds to the architecture shown in FIG. 11, illustrating steering and implement power flow.

In all the schematics, solid, dash-dot and solid-hash lines represent direct hydraulic connections, hydraulic pilot connections and electrical signal connections, respectively.

### DETAILED DESCRIPTION

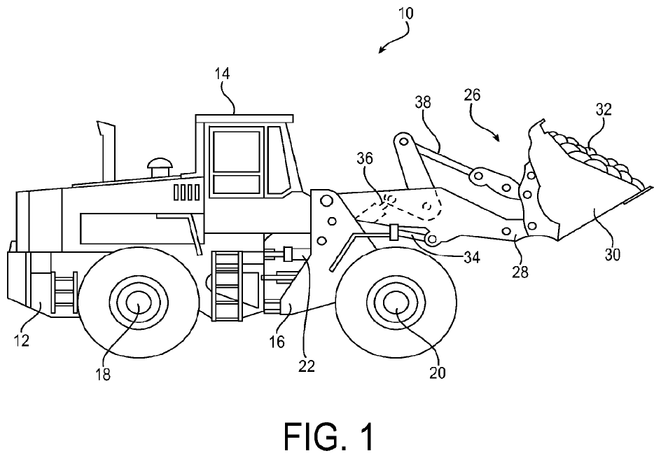

Referring now in detail to the drawings and initially to FIG. 1, an exemplary wheel loader is illustrated generally at reference numeral 10. The wheel loader 10 comprises a rear vehicle part 12 including a cab/compartment 14 and a front vehicle part 16, which parts each comprise a frame and respective drive axles 18 and 20. The vehicle parts 12 and 16 are coupled together with one another in such a way that they can be pivoted relative to one another about a vertical axis by means of hydraulic cylinders 22 which are connected to the two parts on opposite sides of the wheel loader. The hydraulic (steering) cylinders 22 provide for steering, or turning, the wheel loader. The rear vehicle part 12 may house an engine that serves as a prime mover of the loader.

The wheel loader 10 further comprises an apparatus 26 for performing an auxiliary function, such as handling objects or material. The illustrated apparatus 26 comprises a lifting arm unit 28 and an implement 30 in the form of a bucket which is mounted on the lifting arm unit. The bucket 30 is shown filled with material 32. One end of the lifting arm unit 28 is coupled rotatably to the front vehicle part 16 for bringing about a lifting movement of the bucket. The bucket is coupled rotatably to an opposite end of the lifting arm unit for allowing a tilting movement of the bucket.

The lifting arm unit 28 can be raised and lowered in relation to the front part 16 of the vehicle 10 by means of one or more hydraulic (lift) cylinders 34, there being two in the illustrated loader. The hydraulic cylinders 34 are each coupled at one end to the front vehicle part 16 and at the other end to the lifting arm unit 28 at opposite sides of the lifting arm. The bucket 30 can be tilted in relation to the lifting arm unit 28 by means of a third (tilt) hydraulic cylinder 36, which is coupled at one end to the front vehicle part and at the other end to the bucket via a link arm system 38.

The wheel loader 10 is shown and described to facilitate an understanding of the invention and not by way of limitation. As will be appreciated, the wheel loader is just one example of a work machine that may benefit from the present invention. Other types of work machines (including work vehicles) include, without limitation, excavator loaders (backhoes), excavating machines, mining equipment, and industrial applications and the like having multiple actuation functions including lifting arms, booms, buckets, steering and/or turning functions, and traveling means.

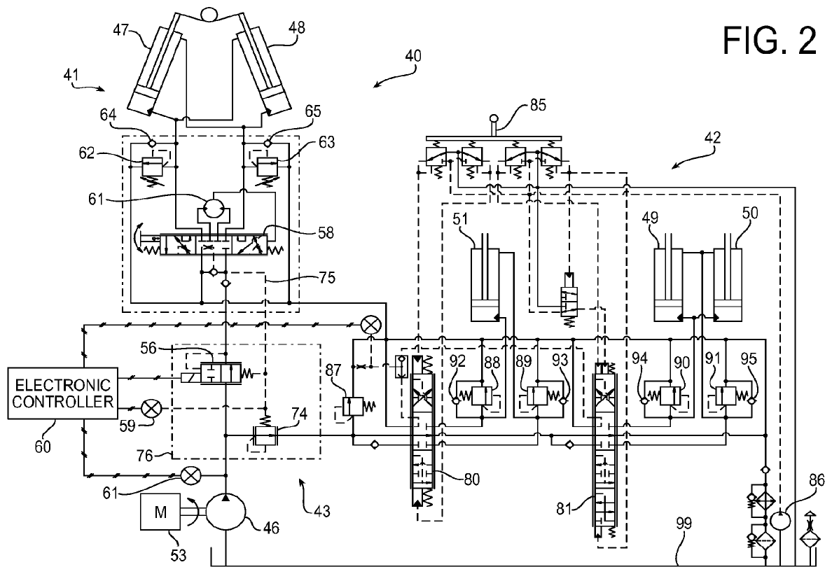

Referring now to FIG. 2, an exemplary hydraulic control system is indicated generally by reference numeral 40. The control system 40 generally comprises a steering section/circuit 41, an auxiliary section/circuit 42, and a priority section/circuit 43. The system 40 has particular application for steering and implement functions in off-road vehicles, such as the above-described loader, and will be described chiefly in that context, although it will be appreciated that the system may have other applications as well.

The system 40 includes a single pump 46 that is used to supply total flow demanded by the steering and auxiliary functions, in particular steering cylinders 47 and 48, lift cylinders 49 and 50, and tilt cylinder 51. The pump 46, which may be of a fixed displacement type, is connected to a prime mover such as the engine 53 of the off-road vehicle 20. In the FIG. 2 embodiment as well as other embodiments of the invention, other forms of drives can be used in place of the engine. For example, an electric motor may replace the engine for driving the pump 46 and the electric motor may be powered by an engine-driven generator and/or by electrical storage connected to an engine-driven generator.

A pre-compensator valve 56 determines the differential pressure across a main steering valve 58 of the steering section and hence the flow rate through the main steering valve. The pre-compensator valve 56 receives a pilot control pressure from a controller 60 that determines the pressure drop across the steering valve. Steering cylinders 47 and 48 receive flow from steering valve 58 and their rod and piston ends are interconnected in such a way that when the left cylinder is being extended, the right one is being retracted, and vice-versa. The controller 60 may have associated therewith one or more pressure sensors for sensing pressures in the circuit, such as a pressure sensor 61 for sensing the pressure at the outlet of the pump 46 and pressure sensor 59 for sensing load sense pressure on line 75.

The use of a pre-compensator before the main steering valve enables the controller 60 to precisely control the flow rate of pressurized fluid in the steering cylinders. The pre-compensator also can be useful in suppressing shock at the start of a steering maneuver when the ground reaction forces are large. Better stability and shock-suppression improves operability and productivity.

In the illustrated embodiment, the steering circuit 41 includes a steering control unit 61, shock valves 62 and 63, and anti-cavitation check valves 64 and 65.

A priority valve 74 operates to split the flow from the pump 46 on a priority basis between the steering circuit 41 and the auxiliary circuit 42. The priority valve is connected to the outlet of the pump 46 and provides a parallel path for the pump flow. The supply flow needed for actuating the implements 49-51 goes through the pilot operated priority valve 74. A load sense (LS) line 75 from the steering valve 58 feeds a pilot port of the priority valve, such that the position of the priority valve 74 is determined as a function of the load present on the steering circuit.

As illustrated, the priority valve and pre-compensator valve 56 can be located in a steering manifold 76.

Until a load is present on the steering circuit, the priority valve 74 directs fluid to the auxiliary (or implements) circuit 42. Whenever a load appears on the steering circuit, the priority valve directs all necessary flow to the steering circuit which has priority over the auxiliary circuit.

The auxiliary circuit/section 42, also referred to as an implement side of the system which, includes open center control valves 80 and 81 for directing the flow, respectively, to tilt cylinder 51 and lift cylinders 49 and 50, also commonly referred to a bucket and boom cylinders (or more generally actuators), respectively.

An operator's joystick 85 (or other suitable operator control) generates pilot pressure signals that actuate the boom and bucket valves in FIG. 2. Pilot pressure may be supplied by an auxiliary pump 86 or other suitable means.

A system pressure relief valve (PRV) 87 limits the maximum pressure in the hydraulic circuit. Like in the steering circuit, the actuators may have associated therewith shock valves 88-91 and anti-cavitation check valves 92-95.

In operation, the engine (prime mover) drives the fixed displacement pump, which is sized to provide sufficient flow for all the functions on the wheel loader at any given instant during its duty cycle. The electronic controller senses the steering LS pressure as the output of a pressure sensor and estimates the correctional signal, if any that it needs to apply to the pre-comp valve. In normal operation, when steering load is within the expected range, the controller may not apply any control signal to the solenoid in which case, differential pressure across the main steering valve is determined by the bias spring in valve alone. Due to constant pressure drop across the steering valve, the flow rate to steering cylinders is proportional to driver's steering input. In the event of load pressure oscillations leading to potential instability or pressure shocks, e.g. at the onset of steering, the controller can manipulate the pressure drop across the steering valve. The controller can calculate and apply a controlling current signal to the solenoid of pre-comp valve. The solenoid exerts a force that opposes the spring bias and moves the pre-comp valve spool to a position that achieves the desired pressure drop across the steering valve. The reduced differential pressure and resulting flow rate for a given opening through the steering valve, serves to stabilize the steering operation.

Usually the occurrence of shock or oscillations in the steering system of a work machine means a sense of loss of control for the operator which results in poor operability and lower productivity. The systems described herein can address machine control and operator comfort.

The remaining pump flow after accounting for supply to the steering cylinders, gives rise to pump outlet pressure that tries to open the priority valve against the spring bias and steering LS pressure on the pilot port. Once the pump pressure overcomes the opposing forces, the rest of the supply flow goes over to the implement section.

Based on the joystick input of the driver, all or part of the flow can be utilized in actuating boom and bucket cylinders and the rest flows back to the reservoir.

If the entire pump flow isn't utilized, the remaining flow will find its way to a reservoir 99 through the open center channel dissipating energy as heat in the process. Hence, there will always be losses present in this circuit.

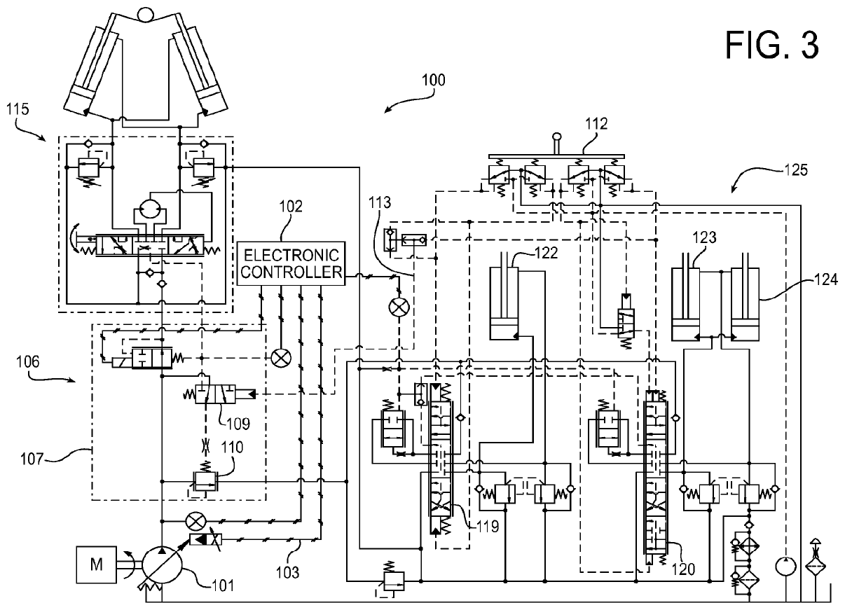

A more energy efficient circuit design can be obtained by providing the ability to control pump flow to meet the changing flow requirements during a duty cycle. FIG. 3 shows a more energy efficient circuit design. The configuration shown in FIG. 3 is essentially the same as FIG. 2 except as discussed below.

In particular, the system 100 of FIG. 3 includes a variable displacement pump 101 in place of the fixed displacement pump of FIG. 2. An electronic controller 102 receives steering LS, implements LS and pump pressure signals. One of the outputs from electronic controller manipulates the pump displacement via command line 103 to reach a supply pressure that exceeds the highest system pressure by a fixed margin. A command on line 103, for example, may be used to control pump swashplate actuator that varies the angle of the swashplate.

The priority circuit 106, which may include a steering manifold block 107, is slightly different from FIG. 2. A 2-position, 3-way valve 109 feeds the pilot port of the priority valve 110. Under a spring bias, valve 109 supplies pump pressure to the pilot port of priority valve 110 that, together with the spring force, keeps the priority valve closed. When the highest pilot pressure signal supplied from the joystick via line 113 overcomes the spring force, the priority valve will be shifted toward its open position, whereupon steering line sense (LS) pressure will be connected to the pilot port of priority valve 110. After supplying the necessary pump flow to the steering circuit 115, the remaining pump flow can be sent to implement section 116 through the proportional priority valve.

Since it is possible to de-stroke the pump completely when no flow is demanded, closed center valves 119 and 120 can be used to control the implement actuators 122-124. There can be brief periods when none of the machine functions are working and hence there is no request for a pump flow. The controller 102 can manipulate the pump displacement to just make up for the leakages and hence avoid losses associated with the open centered configuration shown in FIG. 3.

The system shown in FIG. 3 with a single variable displacement pump 101 has functionality similar to the one described above with a fixed displacement pump, although there are significant differences. Since the pump is of variable type, the electronic controller 102 can adjust pump displacement based on the control architecture of the machine. The boom and bucket valves 119 and 120 may be post-comp close-centered type as shown. Post-comp valves provide flow sharing capability to work functions in case of insufficient pump flow which is useful for work machines. Since the pump can be de-stroked completely if no flow is desired, a close-centered valve can be used instead. The 2-position, 3-way directional control valve 109 connects either the pump outlet pressure or steering LS pressure to the pilot port of priority valve. The highest joystick pilot pressure signal that acts on the pilot port of valve is selected by comparing operator-generated boom and bucket pilot pressure signals.

If there is no operator demand for boom or bucket operation, the valve 109 connects pump pressure to the pilot port of valve 110 under the spring bias. Therefore, when the vehicle is just being steered, the valve 110 remains closed and implement section doesn't receive any pump flow. When the operator moves boom or/and bucket joystick, the highest joystick pilot signal acts against the spring and moves the valve 109 to connect steering LS pressure line to the pilot port of the priority valve 110. Once sufficient pump pressure builds up to overcome the spring and steering LS pressure, the priority valve opens, letting the excess pump flow to flow to the implement side 125. The boom and bucket valves are actuated under their respective joystick pilot pressure inputs and direct the required pump flow to actuator cylinders.

Pump displacement control is carried out by the electronic controller. The electronic controller senses steering LS, implement LS and pump outlet pressure signals and calculates the desired pump displacement.

A control architecture according to the present invention can be flexible enough to allow implementing myriads of pump control algorithms. Two examples are load sense and flow control, but other strategies are also possible. Similar to conventional LS system, pump displacement can be controlled to maintain the pump outlet pressure higher than the highest load pressure by a fixed (or variable) margin. In a flow control architecture, the controller receives joystick inputs for individual implements in addition to pressure signals to capture the “operator's intent”. Based on these joystick inputs, the controller can estimate the flow requirement of each actuator and the total pump flow after accounting for leakages and other losses. These flow rates, after taking into account current operating conditions of the machine, e.g. engine speed, are translated into a desired pump displacement and spool strokes for the implement valves. Computing the desired pump displacement based on total required flow can be thought of as a feed-forward control since all the inputs can be read from the operator's joystick. To improve the accuracy of pump control and system response, a small feedback loop can also be added to monitor the pump outlet pressure to ensure that it always stays above the highest load pressure in the machine by a specified amount.

One advantage of simultaneous pump and valve control in flow control architecture is faster machine response and lower pressure fluctuations compared to a conventional load sense system which leads to higher productivity.

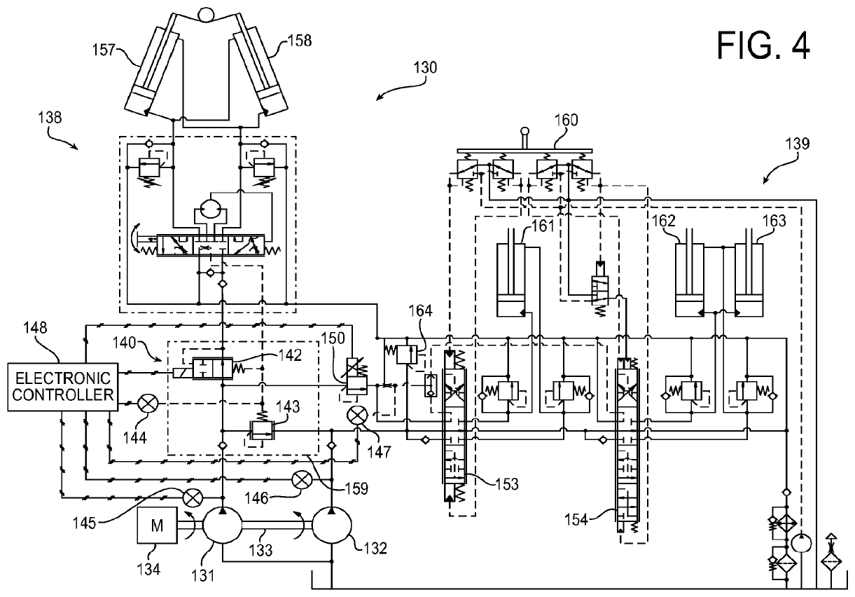

To add more flexibility for system design and control and improve efficiency further, two-pump arrangements can be provided as shown in FIGS. 4-9. A two-pump system over use of a single bigger pump may also result in some cost savings. The systems of FIGS. 4-9 are similar to the above-described systems except as noted below and/or illustrated in the drawings.

The FIG. 4 embodiment is similar to the FIG. 2 embodiment, except that the two-pump system 130 of FIG. 4 employs a fixed displacement pump 131 for steering and fixed displacement pump 132 for implements. Both pumps can be mounted on the same shaft 133 driven by the prime mover 134. The pump 131 supplies flow to the steering circuit 138 and the pump 132 supplies flow to the auxiliary circuit 139. The priority circuit 140 includes a pre-compensating valve 142 and a priority valve 143. The priority valve allows excess flow from the steering pump 131 to be routed to the auxiliary circuit 139. The steering circuit 138, auxiliary circuit 139 and priority circuit 140 are essentially the same as in FIG. 2, except as otherwise noted. Again, various pressure sensors 144-147 are provided for providing pressure information to the controller 148 that controls the pre-compensation valve 142 and an electronic pressure relief valve 150.

Although the implement valves 153 and 154 are shown as open-center type in FIG. 4, a close-centered arrangement is also possible with an electronic PRV 150, on the outlet of the steering pump 131.

In operation, the steering pump 131 first supplies flow to the steering cylinders 157 and 158 on a priority basis and then leftover flow exits the steering manifold block 159 through the priority valve 143 where it combines with flow from the implement pump 132. Movement of the joystick 160 generates boom and bucket pilot pressures that control their respective strokes of the spools of the implement control valves 153 and 154 and direct the required flow to actuator cylinders 161-163. The unused flow, similar to single fixed pump case, finds its way to the reservoir through the open-center valves. When steering pump flow is not needed, steering pump 131 can be de-loaded by de-energizing the electronic pressure relief valve 150 therefore saving some energy compared to a single fixed pump configuration. The main PRV 164 limits the maximum pressure in the system.

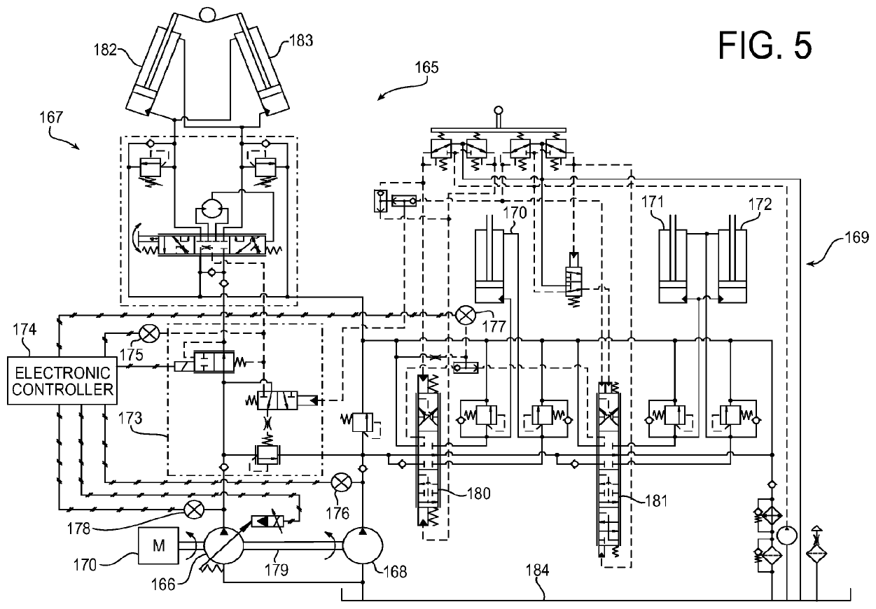

FIG. 5 shows a two-pump system 165 including a variable displacement pump 166 for steering circuit 167 and a fixed displacement pump 168 for the auxiliary/implement circuit 169. Both pumps can be run by an engine 170 as the prime mover. While the fixed displacement pump 168 supplies flow only to implements, variable displacement pump 166 supplies flow to steering on a priority basis but also supplements the flow going to implement cylinders 170-172, if needed. The circuit inside steering manifold block 173 is similar to FIG. 3 with the same functionality of individual components. The controller 174 senses LS pressure of steering and implement sections 167 and 169 as well as both the pump outlet pressures via sensors 175-178 and manipulates the displacement of variable displacement pump via swashplate actuator 179 to meet the steering demand as well as supply any additional flow needed to actuate the working implements. Similar to FIG. 2, implement valves 180 and 181 can be open-center type to allow the pump flow to pass through them in the neutral position when none of the work functions are active.

In operation, the variable steering pump 166 is displacement-controlled to meet the flow requirement of the steering cylinders 182 and 183 on the priority basis and supply any extra flow that is needed to supplement the implement pump flow. When the implement pump flow alone is sufficient to actuate the boom and bucket cylinders 170-172 to meet the operator demanded speed, steering pump 166 is only tasked with supplying the necessary flow to steering cylinders. This way steering and working sections are flow decoupled from each other. Any unused flow in the implement section is channeled to the reservoir 184 through the open-centered (OC) valves 180 and 181. As such, this configuration can be more energy efficient than a single pump circuit since steering pump can be de-stroked when not needed and a fixed displacement pump is usually more efficient than similar-size variable displacement one. The functionality of other components in FIG. 4 has already been described above.

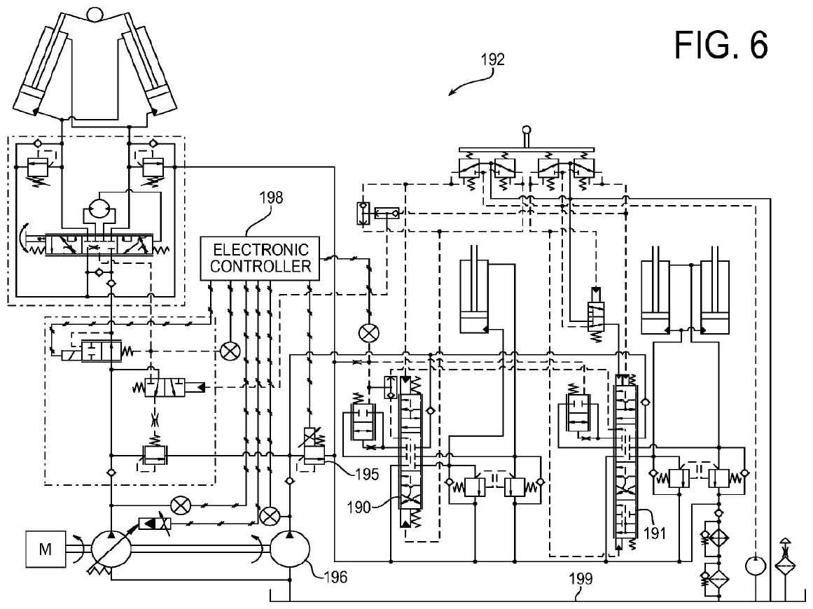

It is also possible to use close-centered boom and bucket valves 190 and 191 instead of open-centered valve, as shown in FIG. 6. The FIG. 6 system 192 is similar to the FIG. 5 system, except a solenoid operated relief valve 195 is used to unload the fixed displacement pump 196 when no flow is desired. The PRV 195 can have a soft spring and can be normally energized and closed to maintain a certain maximum system pressure. But when no flow through the implement section is needed, the electronic controller 198 can de-energize the PRV so that it easily opens and lets the pump flow go through it to the reservoir 199.

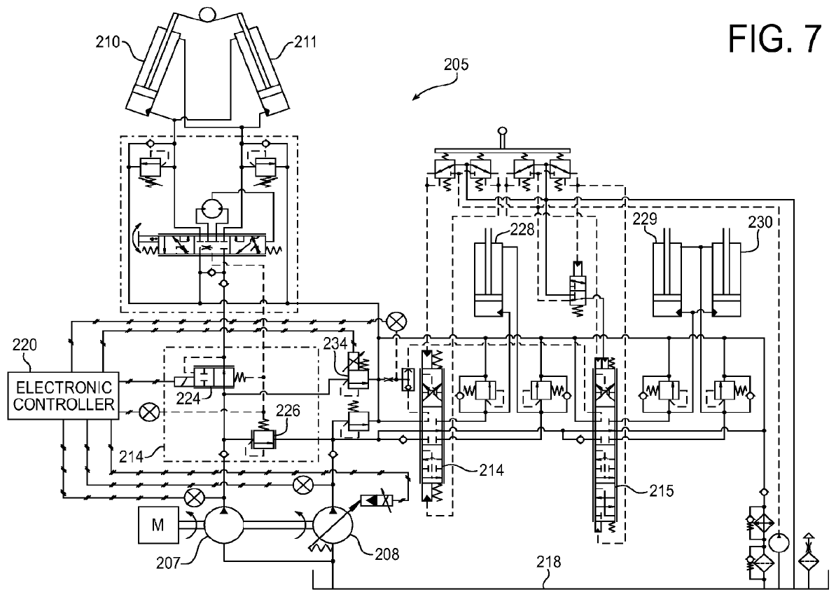

The system 205 shown in FIG. 7 has a fixed displacement pump 207 for steering operation and a variable displacement pump 208 for powering implements. The steering pump first fulfills the flow requirement of the steering cylinders 210 and 211 on a priority basis and the leftover flow is diverted out of steering manifold block 214 where it combines with the flow from variable displacement pump 208. The combined flow is delivered to implement valves 214 and 215 where it is utilized as needed and any remaining flow is passed through the open channel in the valves to the reservoir 218. The variable displacement pump can be controlled by the controller 220 in such a manner that it makes up for the difference in demanded flow in the implement cylinders and flow output of the steering manifold block 214.

In operation, the pre-comp valve 224 controls the flow rate to the steering cylinders 210 and 211. Pressure build up at the steering pump outlet causes the priority valve 226 to open, letting the remaining flow to exit the steering manifold block and merge with the flow from implement pump 208. The combined flow from both pumps powers the boom and bucket actuators 228-230 and any unused flow finds its way to the reservoir 218 through the open channel of open-centered valves. The location of electronic PRV 234 preferably is at the outlet of fixed steering pump 207. Whenever there is no demand for any steering flow or supplemental flow on the implement side, electronic controller can de-energize the PRV and de-load the steering pump by connecting its outlet to the reservoir, similar to FIG. 6. In general, the implement pump control can be subject to achieving higher system efficiency by manipulating its flow in conjunction with steering pump flow.

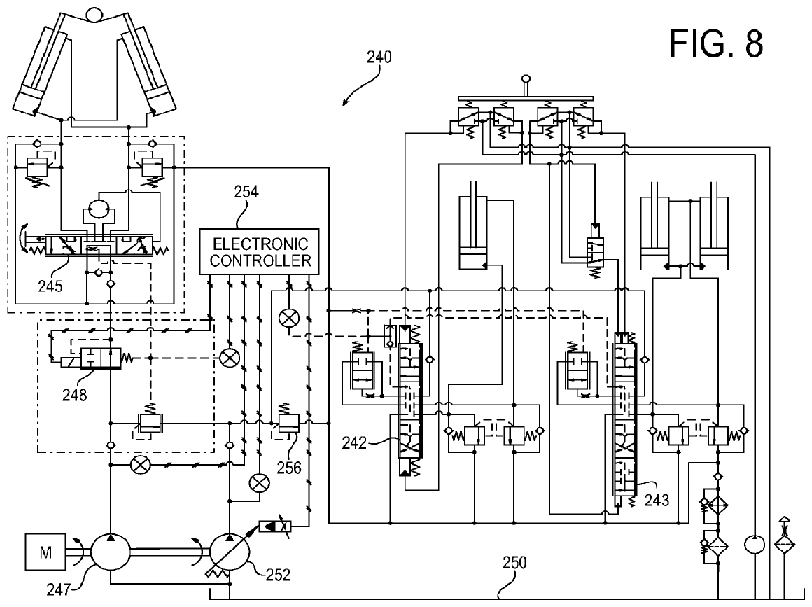

In the FIG. 8 system 240, the implement valves 242 and 243 are closed-center type. The steering valve 245 could be selected to be an open-center one, as shown in FIG. 8. When no flow from the steering pump 247 is needed, the pre-compensator valve 248 could be completely open, directing the pump flow to reservoir 250 through the open channel of the steering valve 245. The variable displacement implement pump 252 meanwhile can be manipulated by the controller 254 to supply the demanded flow. An open-center steering valve allows the steering pump flow to be discharged to the reservoir in the neutral position without any electronic PRV in the circuit. There is a main PRV 256 on the implement side that sets the maximum system pressure.

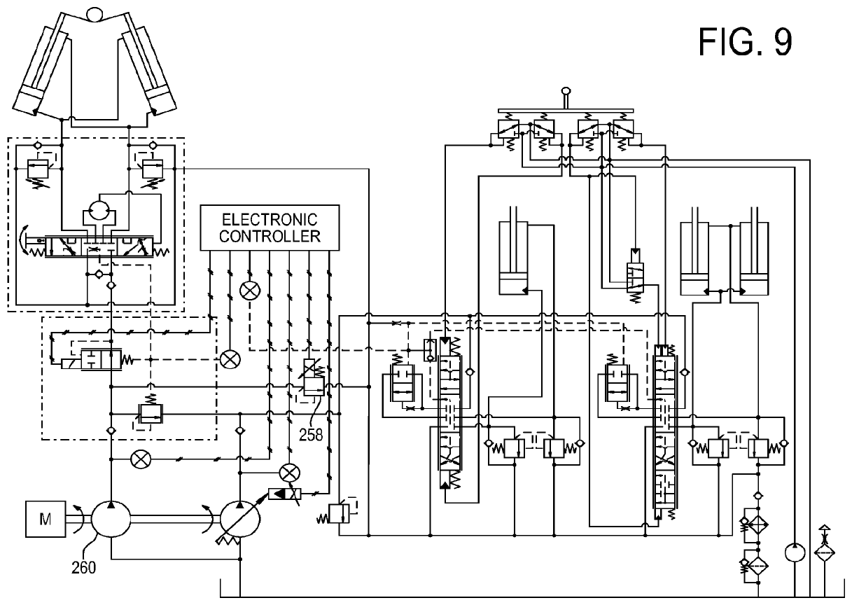

Another solution would be to have a solenoid operated pressure relief valve 258 added instead to the outlet of the fixed displacement steering pump 260, as depicted in FIG. 9. In case of no demanded flow, pressure relief valve 258 could be de-energized and hence open at a very low pump pressure to minimize losses and heat generation.

The variable implement pump in FIGS. 7, 8 and 9 can be adjusted to output just the required amount of flow, therefore it doesn't require any extra outlets for its surplus flow.

The fixed steering pump and variable implement pump configurations shown in FIGS. 7-9 have the advantage of having stand-by flow on the implement side if needed for load holding purposes. With no joystick input from the operator, implement pump can be de-stroked to zero displacement while the fixed steering pump can be outputting a flow proportional to its volume and engine speed. By simultaneously controlling the pre-comp valve opening and energizing current to the electronic PRV, a part of steering pump flow can be forced to enter the implement section and maintain a prescribed pressure. Usually there is some delay involved between pump displacement command from the controller and resulting pressure build-up due to flow. The stand-by flow from steering pump can provide any load-holding functionality during the period of delay.

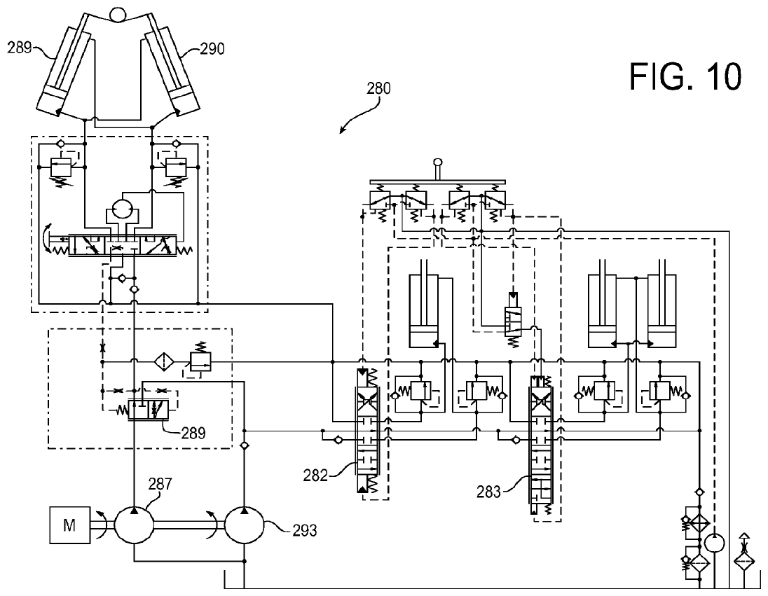

Referring now to FIG. 10, a fixed pump-fixed pump system 280 with open center implement valves 282 and 283, similar to FIG. 4, is shown. A priority valve 286 prioritizes the flow from the steering pump 287 to steering cylinders 289 and 290 with any leftover flow diverted to the implement valves. This contribution from steering pump combined with flow from the implement pump 293 is made available to actuate the working hydraulics of the machine. When there is no steering demand, all the steering pump flow is routed to implement side.

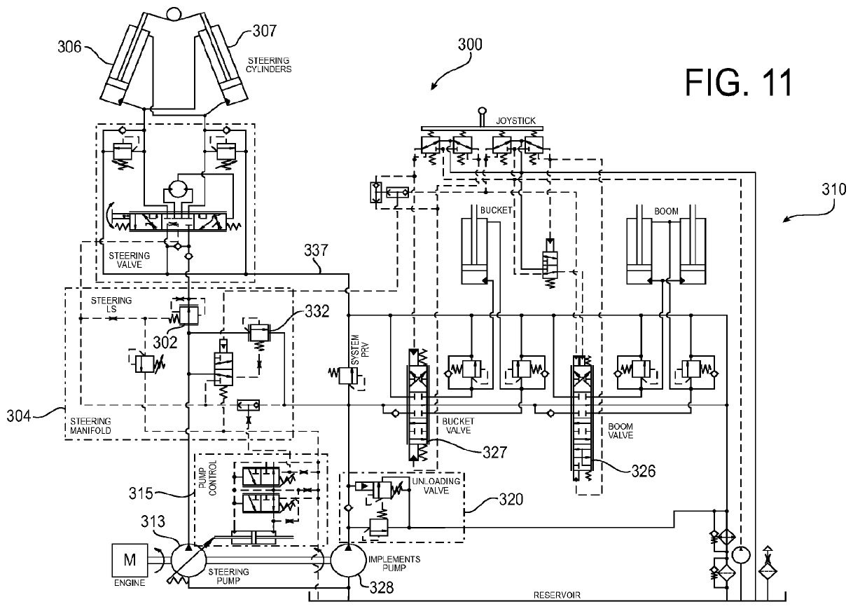

A variable pump-fixed pump architecture 300 shown in FIG. 11 is very similar to FIG. 5 except for several differences. A pressure reducing valve 302 replaces the pre-comp valve in the FIG. 5 embodiment. The steering manifold block 304 essentially accomplishes the same function as the priority valve block in FIG. 5. Based on operator's commands to the joystick and steering load sense pressure signal, steering pump flow is directed to steering cylinders 306 and 307 on a priority basis and excess/unused flow finds its way over to the implement circuit 310. The combined flow powers the work functions as needed. Steering pump 313 is a variable displacement pump which is under load sense control (control mechanism shown in pump control block 315. The higher of two pressures, steering load sense or implement side pressure, determines steering pump displacement at any instant during operation. The variable-fixed pumps system shown in FIG. 11 has the advantage of using lower engine energy over the fixed-fixed pump system in FIG. 10 due to variable nature of steering pump which is controlled to supply only the flow that is needed resulting in lower throttling losses.

Also included in the FIG. 11 system is an unloading valve 320 that works similarly to a standard relief valve in some modes of operation, where the system unloads excess flow across a relief valve. When the implements are not being used, pressure in line 321 will not be high enough to open the unloading valve and total pump flow will return to reservoir through system's open center pathway.

The steering pump will be given priority and the implements pump will be unloaded when no flow is required from it. A shuttle valve 321 in the steering manifold increases the displacement of the steering pump 313 even in situations where there is no steering demand. This flow will be used for the implements, but will always have priority on steering when that is needed. When the pressure supplied to the implements is insufficient, the flow of the implements pump 328 will be added to it by closing the unloading valve 320.

The unloading valve also has the advantage of a slightly larger hysteresis in pressure thresholds by design to avoid frequent loading and unloading of the implements pump 328, unlike a simple pressure relief valve in most existing applications.

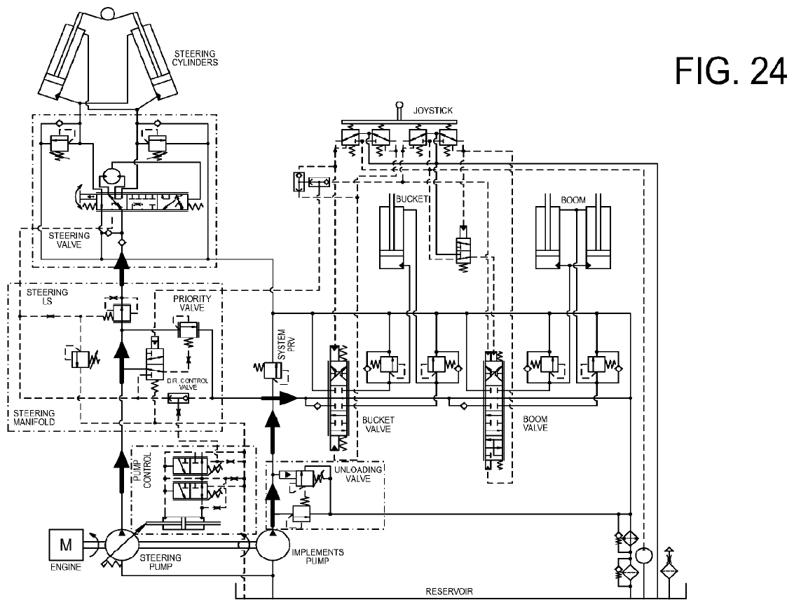

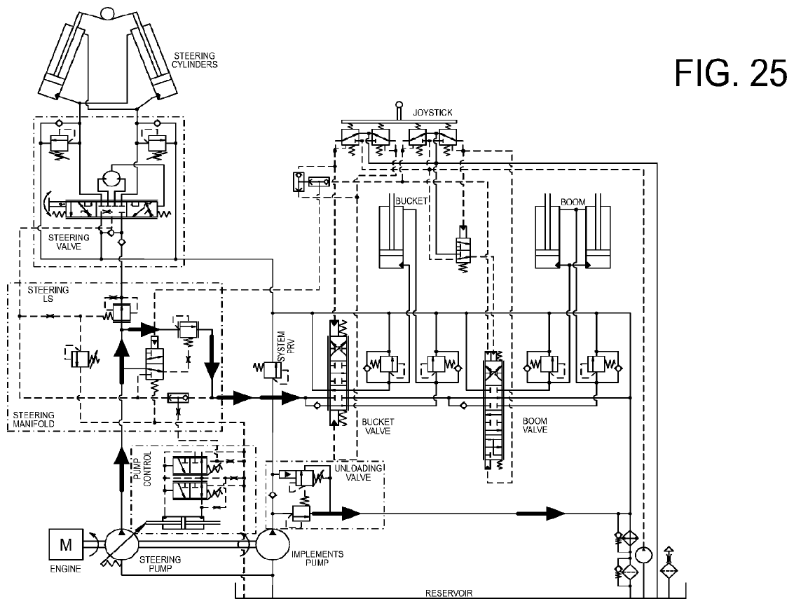

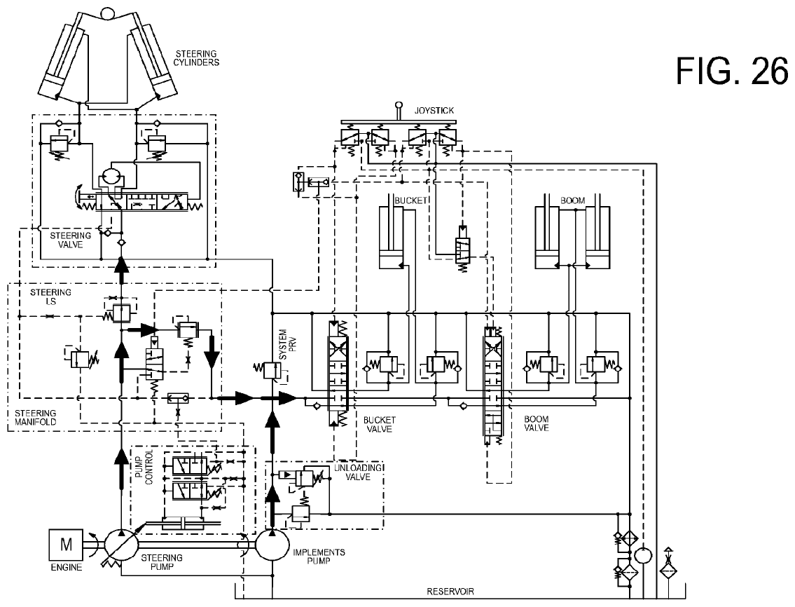

In FIG. 24, the dark arrows illustrate steering only flow. In FIG. 25, the arrows illustrate implement only power flow. In FIG. 26, the arrows illustrate steering and implement power flow.

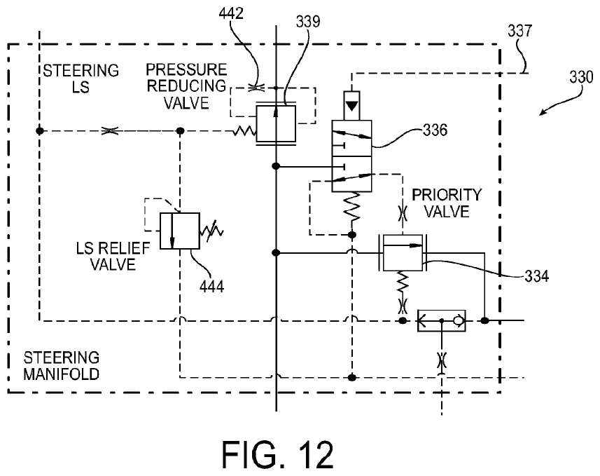

In FIG. 12, a modified steering manifold 330 is shown. FIG. 11 shows the priority valve 332 being fed internally as a standard relief valve, whereas FIG. 12 has the priority valve 334 being fed by the selector valve 336 controlled via line 337 by joystick commands. In FIG. 10 priority is achieved through the combination of the pressure reducing valve 339 to the steering circuit and the priority valve 334. When steering flow is not needed, and other joystick functions are being demanded, flow from the steering pump is diverted to be used on the implements as well as the flow from the implements pump. FIG. 11 shows an alternate embodiment of the same concept of steering manifold. Stability in the pressure and flow being sent to the steering circuit is achieved through the setup of the orifice 442 on the pressure reducing valve 339. Priority to the other implements is achieved through the combination of the pressure reducing valve 39 and the priority valve 334. The pressure from the steering pump gets fed through the selector valve 336 feeding the priority valve when joystick commands are being sensed. The maximum pressure sent to the steering circuit can be achieved through the combination of the setting of the pressure reducing valve as well as that of the LS relief valve 444. Both of these embodiments allow for a proportional priority between steering and the implements. This means that the flow from the steering pump can be used for both steering and the implements without losing the need for steering priority, allowing for a more efficient use of available flow in the system with less wasted energy.

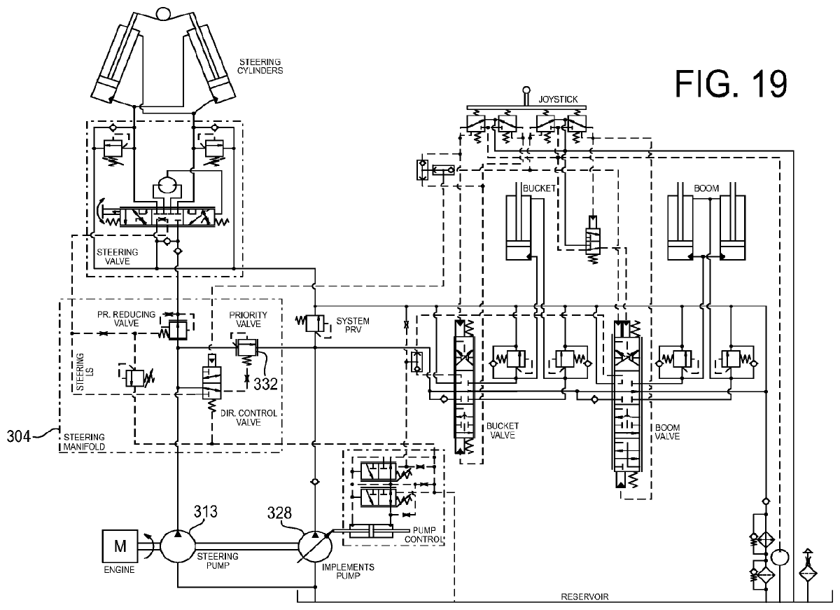

FIG. 19 shows a modification of the FIG. 11 architecture that is the same except for the following differences. The steering pump 313 is the fixed displacement pump and the implements pump 328 is the variable displacement pump. The excess flow from the steering pump can be routed to the implements side through the priority valve 332 in steering manifold 304. The implements pump 328, shown under LS control, can be stroked to supply the remaining flow demanded on the working hydraulics side.

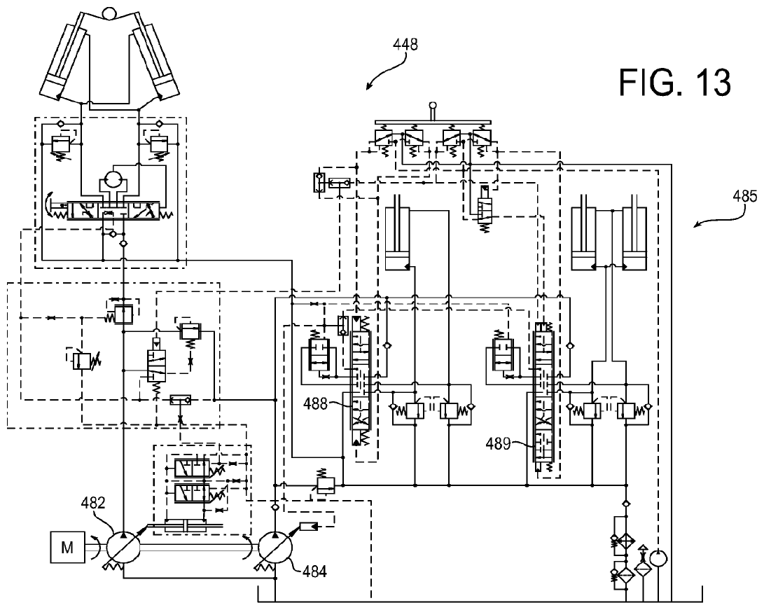

In FIG. 13, a system 448 similar to the system of FIG. 11 can be seen to have variable-variable pumps structure where both the steering pump 482 and auxiliary pump 484 are variable displacement type. Similar to steering pump 482, implement pump 484 could also be under load sense control based on the highest load on the implement side 485. One such example with closed-center main valves 488 and 489 is shown in FIG. 13. These main control valves can also be open-center type as shown in the above-described systems. The advantage with having both pumps of variable displacement type is that hardly any energy is wasted during those periods when machine is just idling. But it also adds more cost and complexity in machine control.

In the above-described systems, the auxiliary/implement valves are controlled by operator joystick commands and variable displacement pumps are under load sense control. In contrast to such a control system, an alternative means of control can be used. As will be appreciated, this new control scheme enables certain advantages over this traditional load sense based control to be obtained. Under this new scheme, valve openings, pump displacements and/or engine throttle are controlled by an electronic controller that takes in joystick inputs, engine speed and other relevant system variables.

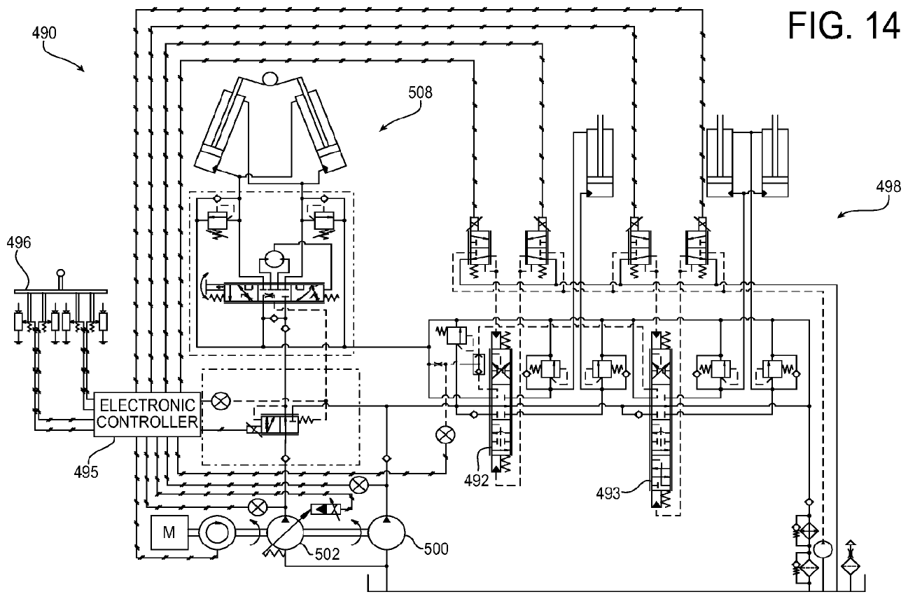

FIG. 14 shows a variable-fixed pumps system 490 with open center valves 492 and 493. The electronic controller 495 receives steering commands and commands from the joystick 496 and computes the total flow demand required for individual functions as well as total flow demand. Based on the current engine speed and the size of fixed displacement implement pump 500, the controller calculates how much extra flow, if any, from steering pump 502 is needed to make for the difference between demand and supply. The controller also senses steering load sense pressure and correlates it to a steering flow demand through built-in look-up tables. Alternatively, it is also possible to have a rotary encoder to sense the movement of steering valve 506 and estimate the steering flow demand.

With knowledge of engine speed and pump sizes, the controller 495 can determine desired displacement for the variable steering pump 502 so that it supplies total flow rate needed to meet any make up flow for implement plus steering demand. The controller also actuates a priority valve, which replaces most of the steering manifold block in FIG. 11, and acts as a flow divider between the steering side 508 and implement side 498. This new flow control concept can also achieve engine management by controlling the throttle for load matching between engine and pumps. By simultaneously adjusting the throttle and pump displacements, demanded flow and power requirements are met while improving the machine efficiency for better fuel economy.

The electronic controller in FIG. 14 controls the implement valves 492 and 493 as opposed to being directly driven by joystick command in circuit in FIG. 11. The valve openings are dictated by the flow demand of individual work functions as well as total pump flow available. Under electronic control, valve openings can be synchronized with flow availability from the pump to avoid any stability issues due to delay in pump response.

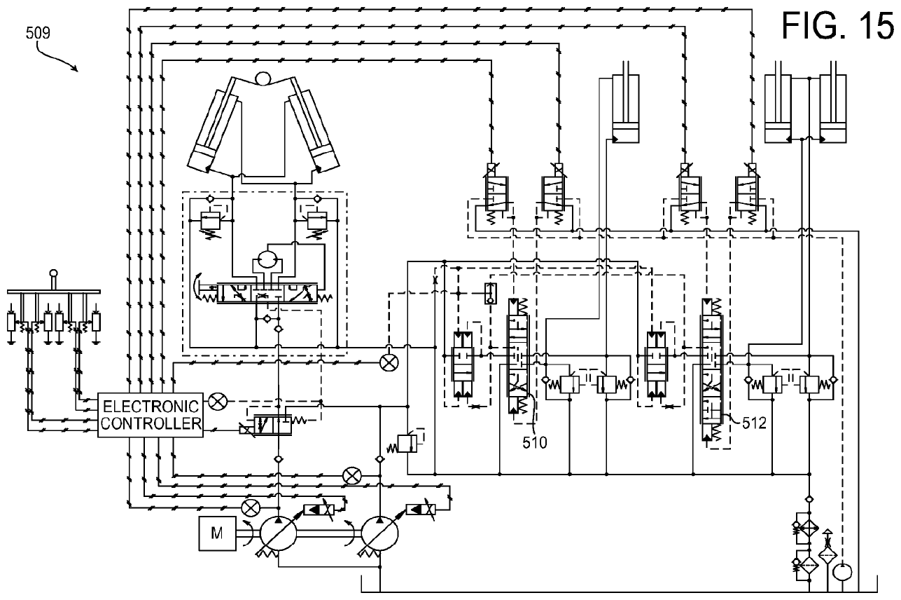

A variable-variable displacement pumps arrangement 509 is shown in FIG. 15. The boom and bucket valves 512 and 510 are closed-center type with a pre-compensator valve. The concept of pressure compensation in multi-actuator systems is well known. The operator intends to control the speed of an actuator by controlling its joystick input that actuates the main control valve. In a multi-actuator system, different actuators usually experience different loads. Given that speed and hence the flow rate entering the actuating cylinder depends on opening area and pressure differential across the metering orifice, the same joystick input may result in different actuator velocity if there is no way to control the differential pressure across the valve. The idea of pressure compensation is to maintain a constant or same pressure drop, independent of individual load or pump pressures, across all metering ports so that actuator velocity is directly a function of operator's joystick command.

It can be shown by analysis that the pre-comp valve shown in the system of FIG. 15 also achieves flow sharing in case of pump over demand in addition to its pressure compensation duties as described in the earlier paragraph. Flow sharing is a desirable property in multi-actuator machines which ensures that actuator with the highest load doesn't lose flow in case of flow over demand from the pump. In a flow sharing circuit, all actuators, regardless of their load, slow down proportionately when demand outstrips the supply.

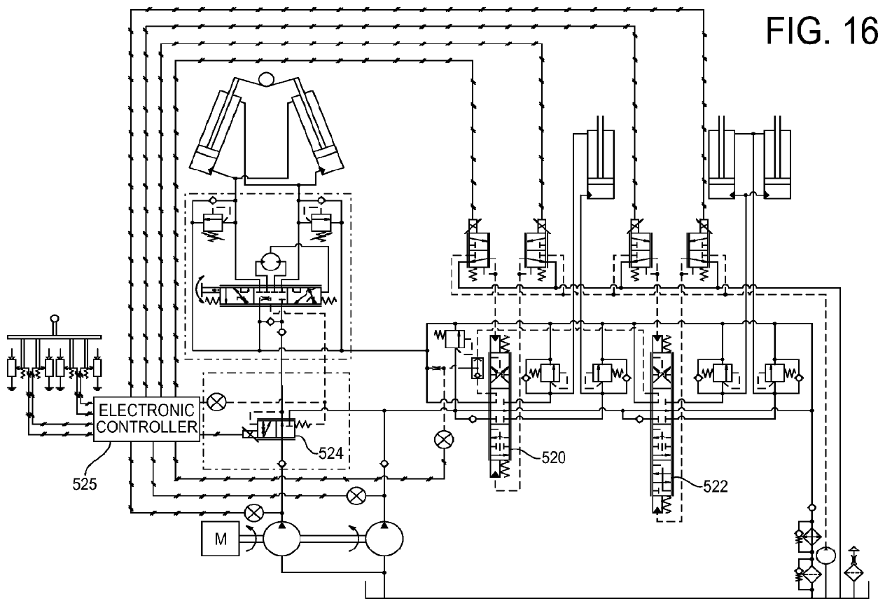

A fixed-fixed displacement pumps circuit is shown in FIG. 16. The only elements that need to be controlled, namely implement side valves 520 and 522 and priority valve 524, get their command from the electronic controller 525 which, as earlier mentioned, monitors all the relevant system parameters as well as joystick inputs and distributes flow to meet the operator demand.

This electronic controller based system enables various advantages over the traditional load sense or other type of machine control concepts. A flow based pump control allows for lower throttling losses in the absence of requirement to maintain a fixed margin pressure. Also, based on operator's input, since pumps and valves are controlled in a feed-forward manner, a system according to the present invention need not suffer from delay and occasional instability in system response normally associated with load sense systems.

This new control architecture lends itself to better engine management since variable pump(s) can be controlled to better utilize available engine power and as a consequence a higher productivity is realized. The new control architecture also enables faster system response, more stability, better engine management, simpler design and/or higher productivity.

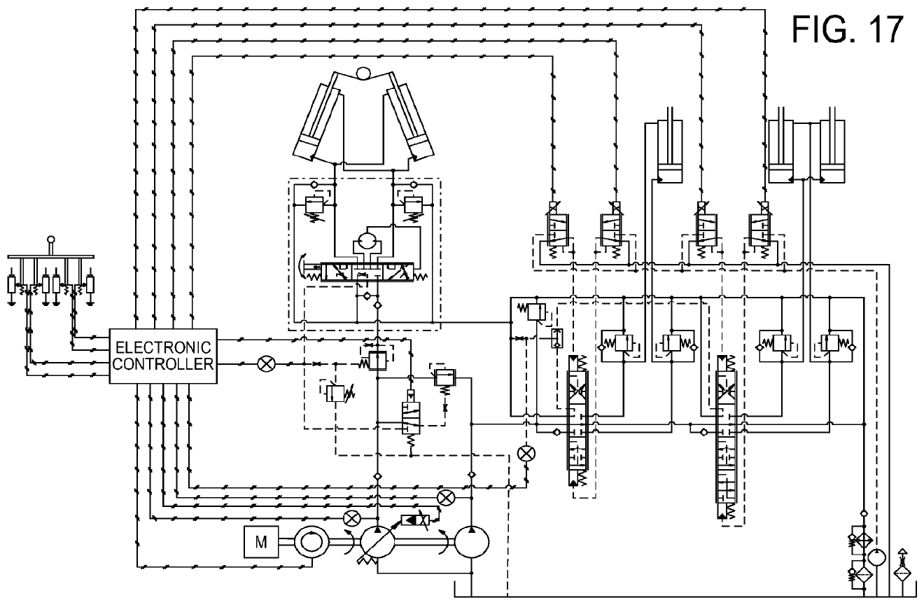

FIG. 17 shows yet another embodiment of the invention with direct electronic control.

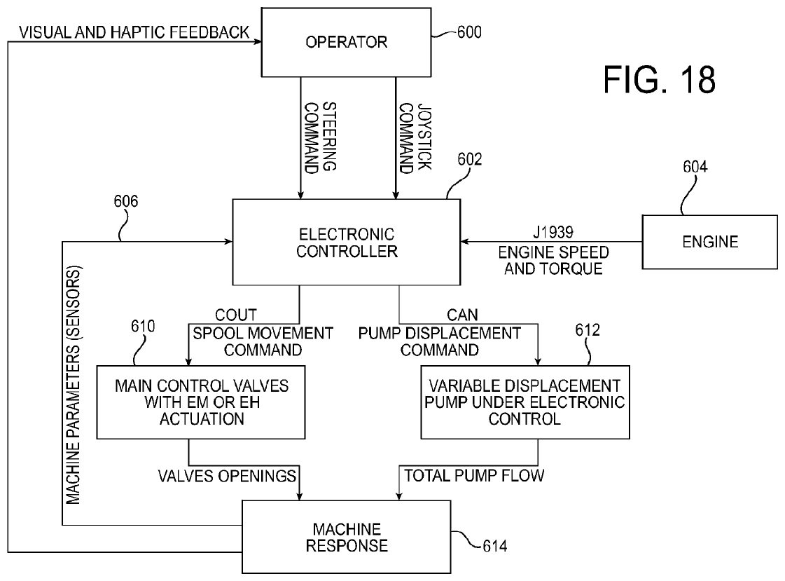

FIG. 18 diagrammatically illustrates an intelligent flow control architecture. Steering and joystick commands from the operator 600 are supplied to the electronic controller 602. The controller received engine speed and/or torque information from the engine 604, as well as machine parameter via associated sensors 606 that sense the machine's response 614 to control inputs. The controller commands spool movements of the main control valves 610 with electromagnetic or electrohydraulic actuation. The controller also controls the displacement of a variable displacement pump(s) 612.

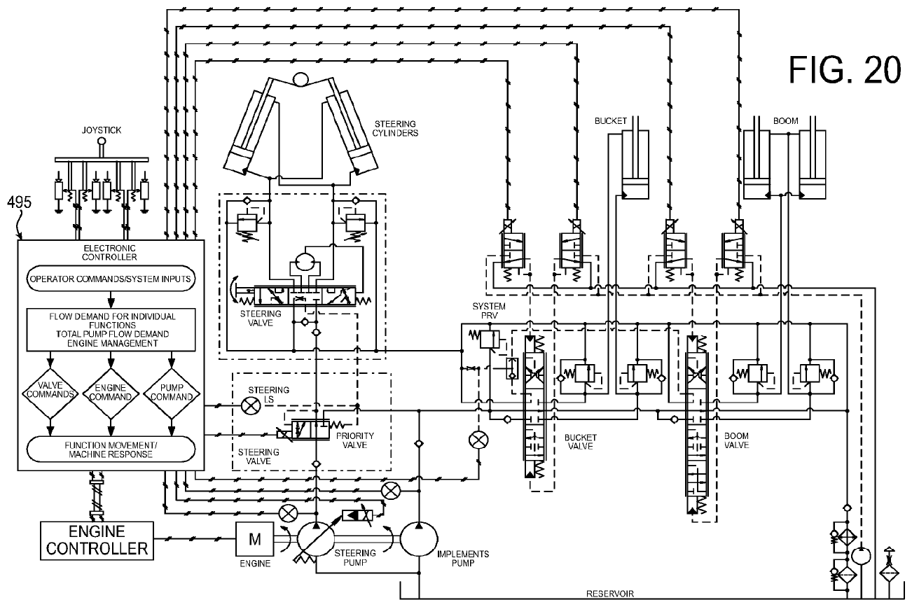

FIG. 20 is the same as FIG. 14, except the functionality of the electronic controller is illustrated in greater detail. The electronic controller receives operator commands and system inputs. The operator commands and system inputs are used by the controller to calculate flow demand for individual functions and total pump flow demand and then provide corresponding valve commands, engine commands and pump commands. The commands determine desired function movement and machine response.

Direct electronic control enables various advantages over the traditional load sense or other type of machine control concepts. A flow based pump control allows for lower throttling losses in the absence of a requirement to maintain a fixed margin pressure. Also, based on operator's input, since pumps and valves are controlled in a feed forward manner, direct electronic control reduces or eliminates delay and occasional instability in system response normally associated with load sense systems. Better engine management also is enabled.

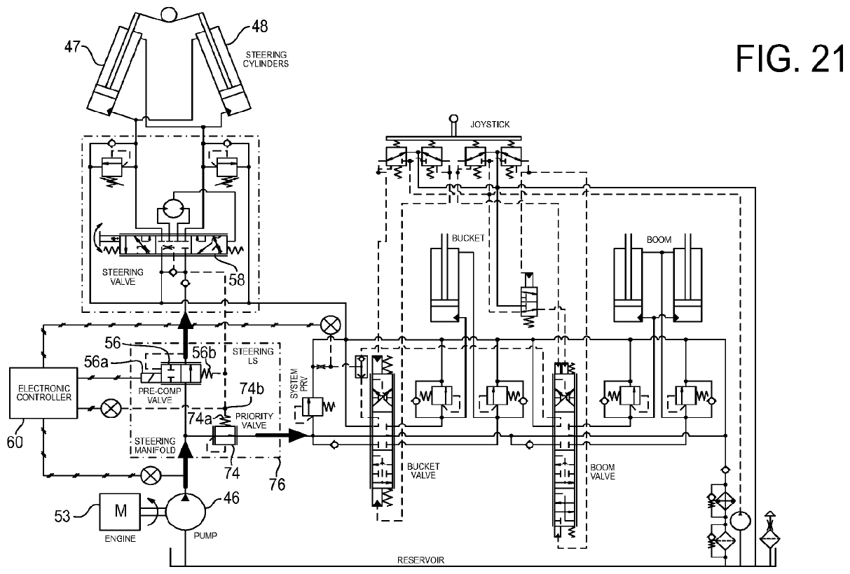

FIG. 21 corresponds to FIG. 2 and illustrates power flow management through use of the electronic controller. The engine 53 (or other motor) drives the fixed displacement pump 46 which is sized to provide sufficient flow for all the functions on the wheel loader at any given instant during its duty cycle. The electronic controller 60 senses the steering LS pressure as the output of a pressure sensor and estimates the correctional signal, if any that it needs to apply to the pre-comp valve 56. In normal operation, when steering load is within the expected range, the controller may not apply any control signal to the solenoid 56a of the pre-comp valve 56 in which case, differential pressure across the main steering valve 58 is determined by the bias spring 56b in pre-comp valve 56 alone. Due to constant pressure drop across the steering valve, flow rate to the steering cylinders 47 and 48 is proportional to driver's steering input.

In the event of load pressure oscillations leading to potential instability or pressure shocks, e.g. at the onset of steering, the controller 60 can manipulate the pressure drop across the steering valve. The controller calculates and applies a controlling current signal to the solenoid 56a of the pre-comp valve 56. The solenoid exerts a force that opposes the bias of the spring 56b and moves the pre-comp valve spool to a position that achieves the desired pressure drop across the steering valve. The reduced differential pressure and resulting flow rate for a given opening through the steering valve, serves to stabilize the steering operation.

Usually the occurrence of shock or oscillations in the steering system of a work machine means a sense of loss of control for the operator which results in poor operability and lower productivity. Therefore, the proposed arrangement addresses a significant issue related to machine control and operator comfort compared to their traditional counterparts.

The remaining pump flow after accounting for supply to the steering cylinders, gives rise to pump outlet pressure that tries to open the priority valve 74 against the bias of priority valve spring 74a and steering LS pressure on the pilot port 74b. Once the pump pressure overcomes the opposing forces, rest of the supply flow goes over to the implements section. The distribution of pump flow when the priority valve has been opened is shown by large arrows in FIG. 21. The steering manifold 76 prioritizes steering over other work functions since having the ability to steer the vehicle at all times is the most critical aspect.

Based on the joystick input of the driver, all or part of the flow can be utilized in actuating boom and bucket cylinders and the rest flows back to the reservoir.

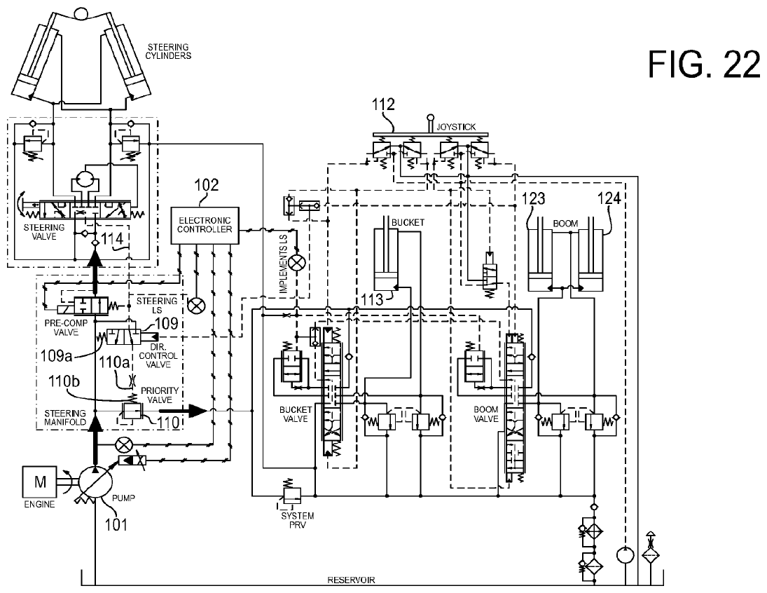

FIG. 22 corresponds to FIG. 3 and illustrates power flow management through use of the electronic controller. The system of FIG. 22 with a single variable displacement pump has functionality similar to that described above for the FIG. 21 system using a fixed displacement pump except for several significant differences. Since the pump 101 is of variable type, the controller 102 can adjust its displacement based on the control architecture of the machine. The boom and bucket valves can be post-comp close-centered type as shown. Post-comp valves provide flow sharing capability to work functions in case of insufficient pump flow which is useful for work machines. Since the pump can be de-stroked completely in case no flow is desired, a close-centered valve can be used. A 2-position, 3-way directional control valve 109 connects either the pump outlet pressure or steering LS pressure to the pilot port 110a of priority valve 110. The highest joystick pilot pressure signal that acts on the pilot port of valve 110 is selected by comparing operator generated boom and bucket pilot pressure signals, as shown in FIG. 22.

If there is no operator demand for boom or bucket operation, the directional control valve 109 connects pump pressure to the pilot port 110a of priority valve 110 under the biasing force of priority valve spring 110b. Therefore, when the vehicle is just being steered, priority valve 110 remains closed and the implements section doesn't receive any pump flow. When the operator moves the boom or/and bucket joystick 112, the highest joystick pilot signal acts against the spring 109a of the directional control valve 109 and moves the valve 109 to the left, thereby connecting the steering LS pressure line 114 to the pilot port 110a of the priority valve 110. Once sufficient pump pressure builds up to overcome the spring and steering LS pressure, the priority valve opens, providing excess pump flow to the implements side. The boom and bucket valves are actuated under their respective joystick pilot pressure inputs and direct the required pump flow to actuator cylinders 113, 122 and 124. The distribution of pump flow when the priority valve has been opened is shown by large arrows in FIG. 22.

Displacement control of the pump 101 is carried out by the electronic controller 102. The electronic controller senses steering LS, implements LS and pump outlet pressure signals and calculates the desired pump displacement. The control architecture proposed in this and other embodiments according to the invention is flexible enough to allow implementing myriads of pump control algorithms. Two examples are load sense and flow control, but other strategies are also possible. Similar to a conventional LS system, pump displacement can be controlled to maintain the pump outlet pressure higher than the highest load pressure by a fixed (or variable) margin.

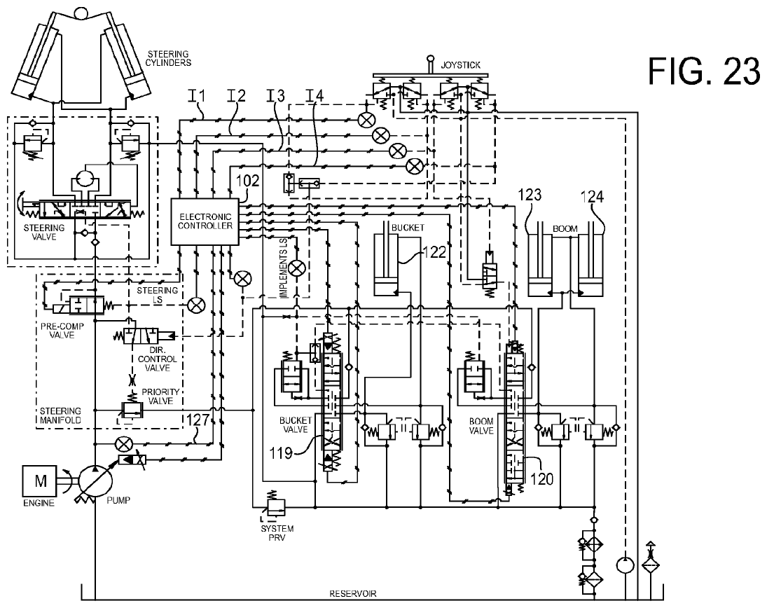

In a flow control architecture, controller receives joystick inputs for individual implements in addition to pressure signals to capture the “operator's intent”, as shown in FIG. 23 which is an adaptation of the architecture shown in FIG. 22. Based on these joystick inputs 11, 12, 13 and 14, the controller 102 estimates the flow requirement of each actuator 122, 123, 124 and the total pump flow after accounting for leakages and other losses. These flow rates, after taking into account current operating condition of the machine, e.g. engine speed, are translated into a desired displacement of the pump 101 and spool strokes for the implement valves 119 and 120. The electronic controller sends out command signals for controlling the pump displacement as well as boom and bucket valve movement to their desired values. Computing the desired pump displacement based on total required flow can be thought of as a feed-forward control since all the inputs are read from operator's joystick. To improve the accuracy of pump control and system response, a small feedback loop 127 can be added that monitors the pump outlet pressure to ensure that it always stays above the highest load pressure in the machine by a certain amount.

One advantage of simultaneous pump and valve control in a flow control architecture is faster machine response and lower pressure fluctuations compared to a conventional load sense system which leads to higher productivity.

Although the invention has been shown and described with respect to a certain preferred embodiment, it is obvious that equivalent alterations and modifications will occur to others skilled in the art upon the reading and understanding of this specification and the annexed drawings. In particular regard to the various functions performed by the above described components, the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention can have been disclosed with respect to only one of the several embodiments, such feature can be combined with one or more other features of the other embodiments as may be desired and advantageous for any given or particular application.

1. A hydraulic system for a work machine, comprising:
a priority circuit including at least a first priority actuator and a priority control valve for controlling the supply of hydraulic fluid to the first priority actuator;
an auxiliary circuit including at least a first auxiliary actuator and at least a first auxiliary control valve for controlling the supply of hydraulic fluid to the first auxiliary actuator;
at least a first pump for producing a flow of hydraulic fluid;
an electric motor for driving the first pump;
a priority valve for distributing the flow from the first pump to the priority circuit and the auxiliary circuit for operating the first priority actuator and the first auxiliary actuator;
a manually operated input device for allowing a machine operator to input commands for commanding operation of the first priority actuator and the first auxiliary actuator and for outputting command signals indicative of the commands; and
a controller configured to receive the command signals from the manually operated input device and a plurality of system parameters, and to control operation of the electric motor, the first pump and the priority valve.

2. The hydraulic system of claim 1, wherein the controller is provided with a load sense signal indicative of the load acting on the first priority actuator.

3. The hydraulic system of claim 2, wherein the priority valve and a displacement of the first pump are controlled by the controller.

4. The hydraulic system of claim 2, wherein the first priority actuator and the priority control valve are used to perform a steering function in the work machine, and wherein the controller correlates the load sense signal to a steering flow demand through built-in look-up tables or wherein a rotary encoder is used to sense the movement of a steering command valve and estimate steering flow demand.

5. The hydraulic system of claim 1, including a plurality of auxiliary actuators and auxiliary control valves, including the first auxiliary actuator and auxiliary control valve, for carrying out respective work functions, and wherein the controller computes the total flow required by the plurality of auxiliary actuators for carrying out the work functions.

6. The hydraulic system of claim 5, wherein valve openings of the auxiliary control valves are dictated by a flow demand of individual work functions as well as total pump flow available, and/or openings of the auxiliary control valves are synchronized by the controller with flow availability from the pump to avoid any stability issues due to delay in pump response.

7. The hydraulic system of claim 1, including a second pump for producing hydraulic flow.

8. The hydraulic system of claim 7, wherein the second pump supplies hydraulic flow to the auxiliary circuit, and the first pump supplies hydraulic flow to the priority circuit.

9. The hydraulic system of claim 8, wherein the first pump supplies hydraulic flow to the priority circuit on a priority basis, with any excess flow being from the first pump supplied to the auxiliary circuit.

10. The hydraulic system of claim 8, wherein the first pump is a variable displacement pump.

11. The hydraulic system of claim 7, wherein when there is no demand in the priority circuit, all pump flow from the first and second pumps is routed to the auxiliary circuit.

12. The hydraulic system of claim 7, wherein the controller calculates how much extra flow, if any, from the first pump is needed to make up for the difference between a demand by the at least first auxiliary actuator and a supply from the second pump.

13. The hydraulic system of claim 1, wherein the controller directly controls the auxiliary control valve.

14. The hydraulic system of claim 1, wherein the priority circuit is a steering circuit of a work machine and the auxiliary circuit is an implement circuit of the work machine.

15. A hydraulic system for a work machine, comprising:
a priority circuit including at least a first priority actuator and a priority control valve for controlling the supply of hydraulic fluid to the first priority actuator and for providing a load sense signal indicative of the load acting on the first priority actuator;
an auxiliary circuit including at least a first auxiliary actuator and at least a first auxiliary control valve for controlling the supply of hydraulic fluid to the first auxiliary actuator;
at least a first pump for producing a flow of hydraulic fluid; and
a priority valve for distributing the flow from the pump to the priority circuit and auxiliary circuit for operating the respective actuators thereof, with priority being given to the priority circuit as a function of the load sense signal.

16. The hydraulic system of claim 15, including a pressure reducing valve connected between the pump and the priority control valve for controlling the flow rate of hydraulic fluid supplied to the priority control valve.

17. The hydraulic system of claim 15, including a pre-compensation valve connected between the pump and the priority control valve for controlling the flow rate of hydraulic fluid supplied to the priority control valve.

18. The hydraulic system of claim 1, wherein the pressure reducing valve or the pre-compensation valve receive a pilot control pressure from a controller that determines the pressure drop across the priority control valve.

19. The hydraulic system of claim 18, wherein the controller has associated therewith one or more pressure sensors for sensing pressures in the system, such as a pressure sensor for sensing the pressure at the outlet of the pump and a pressure sensor for sensing the load sense pressure.

20. The hydraulic system of claim 1, wherein a load sense supplies the load sense signal to a pilot port of the priority valve, such that the position of the priority valve is determined as a function of the load present on the first priority actuator.
